(19) United States
(12) Patent Application Publication
(10) Pub. No.: US 2011/0070350 A1
(43) Pub. Date: Mar. 24, 2011

(54) Matcha green tea konnyaku noodle and method of preparing thereof

(76) Inventor: Seitaro Nakaoka, Santa Monica, CA (US)

(21) Appl. No.: 12/586,085

(22) Filed: Sep. 18, 2009

(51) Int. Cl. A23L 1/0528; A23L 1/214; A23P 1/00

(52) U.S. Cl. 426/578

(57) ABSTRACT

Disclosed is a matcha (finely-powdered green tea) green tea konnyaku (konjac) noodle (shirataki) and a method of preparing thereof.

The matcha green tea noodle is a coagulate food comprising raw material of konnyaku and green tea powder as a low calorie diet.

### BACKGROUND OF THE INVENTION

Present invention relates to a matcha (finely-powdered green tea) green tea konnyaku (konjac) noodle (shirataki) and method of preparing thereof.

Heretofore, matcha, though its flavor and taste are good and attractive, had been considered impossible to get only powdered tea leaves as a low calorie meal since a kind of powdered green tea is used with ice cream, mochi, soba (buckwheat) noodles and would choke people who want to take green tea leaves without wheat flour nor buckwheat.

As you know, the wheat flour and buckwheat cause the allergy that some people have.

Therefore, taking only matcha green tea food as a low calorie diet without any allergies was considered impossible, whereas it had long been expected to become reality.

### SUMMARY OF THE INVENTION

Invention is a kind of things, processes and matters which is to turn an impossibility into a possibility.

According to the present invention, to begin with, add matcha (finely-powdered green tea) green tea to a blender filled with water and blend for a few minutes. After that, add raw materials of konnyaku (konjac) powder.

A few hours later, add a coagulant (mixed water with calcium hydroxide powder) to the green tea konnyaku paste, shape noodles with basket or sieve which have meshes, and boil the noodles with hot water.

Finally, the matcha green tea konnyaku noodles are ready.

### BRIEF DESCRIPTION OF THE DRAWINGS

The invention disclosed herein will be understood better with reference to the following drawings of which;

FIG. 1 is a view of a matcha (finely-powdered green tea) green tea powder, raw materials of konnyaku (konjac) powder, and a big pot filled with water.

FIG. 2 is a view of the pot filled with matcha green tea konnyaku paste and a coagulant (mixed water with calcium hydroxide powder) to the konnyaku paste.

FIG. 3 is a view of the matcha green tea konnyaku paste and noodle, a basket that has meshes, and boiled water. There are matcha green tea konnyaku noodle in other big pot filled with boiled water.

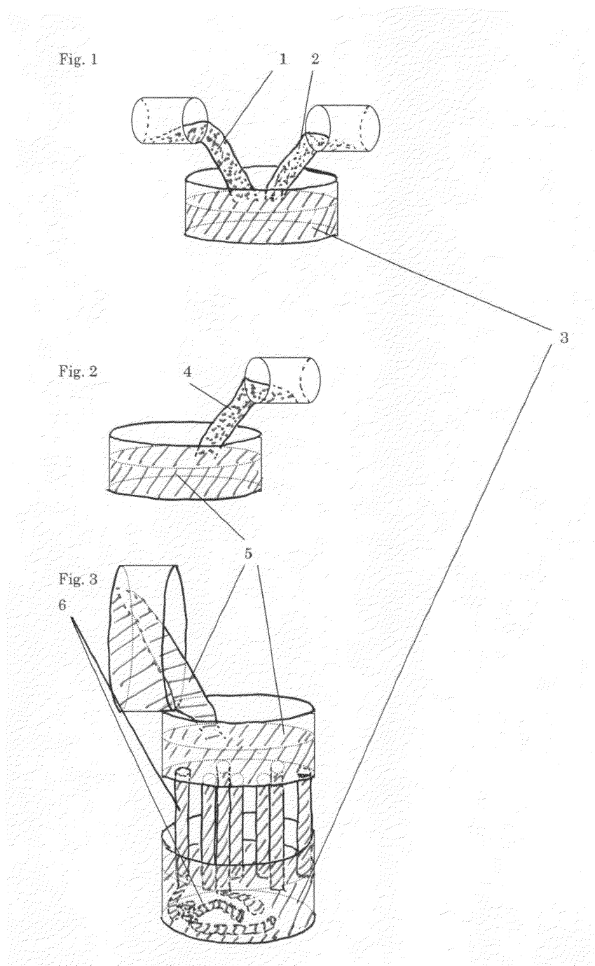

Referring to FIG. 1 and FIG. 2, there are shown matcha green tea powder 1, konnyaku powder 2, water 3, a coagulant to the green tea konnyaku paste 4, the konnyaku paste 5, and prepared matcha green tea konnyaku noodle 6 in FIG. 3, ready for eat.

### DETAILED DESCRIPTION OF THE INVENTION

In my invention, prepare water, konnyaku (konjac) powder, a coagulate food comprising raw material of konnyaku, and matcha (finely-powdered green tea). (FIG. 1).

In this case konnyaku powder is particularly used for this purpose since it has a specific nature of considerable low calories diet.

Then mix matcha green tea powder and water in the pot. (FIG. 1).

After that, add the konnyaku powder and blend the konnyaku green tea paste in the pot. (FIG. 1).

A few hours later, shape noodles from the past with a basket or sieve which have meshes adding a coagulant (water mixed with calcium hydroxide powder) to the konnyaku paste. (FIG. 2).

Put those noodles in boiled water, and then a coagulate food (matcha green tea konnyaku noodle) can be produced. (FIG. 3).

Furthermore, various kinds of green tea leaves can be added into said matcha green tea powder. It would be making another taste.

Thus, various kinds of the matcha green tea konnyaku noodle as a low calorie diet can be made successfully.

In addition, this coagulate food can be eaten like ordinary noodles and pasta without some allergies against flour or buckwheat.

What is claimed is:

1. Method for producing a coagulate food comprising raw material of konnyaku (konjac) and matcha (finely-powdered green tea) green tea leaves and said coagulate food.

2. To use various kinds of green tea leaves instead of the matcha green tea leaves.

3. To make any shapes of matcha green tea konnyaku noodles. For example, it could be various types of pasta or block shapes.
